(19) United States
(12) Patent Application Publication
(10) Pub. No.: US 2025/0117714 A1
(43) Pub. Date: Apr. 10, 2025

(54) METHOD FOR GENERATING TEXT TRAINING SAMPLE BASED ON LARGE MODEL, AND ELECTRONIC DEVICE

(71) Applicant: BAIDU INTERNATIONAL TECHNOLOGY (SHENZHEN) CO., LTD., Shenzhen (CN)

(72) Inventors: Jinchang Luo, Guangdong (CN); Bolei He, Guangdong (CN); Kunbin Chen, Guangdong (CN); Wei He, Guangdong (CN)

(73) Assignee: BAIDU INTERNATIONAL TECHNOLOGY (SHENZHEN) CO., LTD., Shenzhen (CN)

(21) Appl. No.: 18/988,228

(22) Filed: Dec. 19, 2024

(30) Foreign Application Priority Data
Sep. 12, 2024 (CN) 202411280715.7

(51) Int. Cl. G06N 20/00; G06F 16/242

(52) U.S. Cl. CPC G06N 20/00; G06F 16/242

(57) ABSTRACT

A method for generating a text training sample based on a large model includes: obtaining at least two query clusters by clustering at least two queries; obtaining a first query from each query cluster; generating at least two second queries under a set theme through a first large model by taking the first query as an example; and generating a first text training sample for fine-tuning a second large model based on the second query.

### CROSS-REFERENCE TO RELATED APPLICATION

The present application claims priority to and benefits of Chinese Patent Application Serial No. 2024112807157, filed on Sep. 12, 2024, the entire content of which is incorporated herein by reference.

### TECHNICAL FIELD

The disclosure relates to a technical field of artificial intelligence, in particular to the technical fields of large model, model fine-tuning, deep learning, natural language processing and the like, and can be applied to artificial intelligence-based interactive scenes, such as application scenes of generative search, intelligent assistant, intelligent customer service and the like, in particular to a method for generating a text training sample based on a large model, an apparatus for generating a text training sample based on a large model and an electronic device.

### BACKGROUND

A large model can handle a variety of tasks, such as knowledge question and answer, Natural Language to Structured Query Language (NL2SQL), information extraction, meetings, leave, etc. Taking knowledge question and answer as an example, a user can propose a question as an interaction context, and the large model can make an appropriate response. In order to make the performance of the large model meet the expectations of various tasks, it is usually necessary to use a large number of text training samples to tune the model. However, if the diversity of text training samples is poor, the generalization of the fine-tuned large model based on such text training samples will be low. Therefore, it is important to generate diversified text training samples to improve the generalization of the large model.

### SUMMARY

The disclosure provides a method for generating a text training sample based on a large model, an apparatus for generating a text training sample based on a large model and an electronic device.

According to a first aspect of the disclosure, a method for generating a text training sample based on a large model is provided. The method includes: obtaining at least two query clusters by clustering at least two queries; obtaining a first query from each query cluster; generating at least two second queries under a set theme through a first large model by taking the first query as an example; and generating a first text training sample for fine-tuning a second large model based on the second query.

According to a second aspect of the disclosure, a method for fine-tuning a large model is provided. The method includes: obtaining a first text training sample, in which the first text training sample is generated based on the method of the first aspect; and fine-tuning the large model based on the first text training sample.

According to a third aspect of the disclosure, a question and answer method based on a large model is provided. The method includes: obtaining a target query; generating a prompt corresponding to the target query, in which the prompt is configured to indicate a rule based on which a response corresponding to the target query is generated; and obtaining a response corresponding to the prompt output by a large model by inputting the prompt into the large model, in which the large model is a large model fine-tuned by using a first text training sample, and the first text training sample is generated based on the method for generating the text training sample based on the large model of the first aspect.

According to a fourth aspect of the disclosure, an electronic device is provided. The electronic device includes:
at least one processor; and
a memory communicatively connected to the at least one processor;
in which the memory stores instructions executable by the at least one processor, and the instructions are executed by the at least one processor to cause the at least one processor to perform the method for generating the text training sample based on the large model of the first aspect, the method for fine-tuning a large model of the second aspect, or the question and answer method based on the large model of the third aspect.

According to a fifth aspect of the disclosure, a non-transitory computer-readable storage medium having computer instructions stored thereon is provided. The computer instructions are configured for causing a computer to execute the method for generating the text training sample based on the large model of the first aspect, the method for fine-tuning a large model of the second aspect, or the question and answer method based on the large model of the third aspect.

### BRIEF DESCRIPTION OF THE DRAWINGS

The attached drawings are for better understanding the solution and do not constitute a limitation of this disclosure, in which:

FIG. 1 is a flowchart of a method for generating a text training sample based on a large model according to an embodiment of the disclosure.

FIG. 2 is a flowchart of a method for generating a text training sample based on a large model according to another embodiment of the disclosure.

FIG. 3 is a flowchart of a method for generating a text training sample based on a large model according to yet another embodiment of the disclosure.

FIG. 4 is a flowchart of a method for generating a text training sample based on a large model according to further another embodiment of the disclosure.

FIG. 5 is a flowchart for a method for fine-tuning a large model according to an embodiment of the disclosure.

FIG. 6 is a flowchart for a question and answer method based on a large model according to an embodiment of the disclosure.

FIG. 7 is a schematic diagram of an apparatus for generating a text training sample based on a large model according to an embodiment of the disclosure.

FIG. 8 is a schematic diagram of an apparatus for fine tuning a large model according to an embodiment of the disclosure.

FIG. 9 is a schematic diagram of a question and answer apparatus based on a large model according to an embodiment of the disclosure.

FIG. 10 is a schematic block diagram of an exemplary electronic device that is configured to implement a method for generating a text training sample based on a large model, a method for fine-tuning a large model, or a question and answer method based on a large model.

### DETAILED DESCRIPTION

The following description of exemplary embodiments of the disclosure is provided in combination with the accompanying drawings, which includes various details of embodiments of the disclosure to aid in understanding, and should be considered merely exemplary. Those skilled in the art understood that various changes and modifications of the embodiments described herein can be made without departing from the scope and spirit of the disclosure. For the sake of clarity and brevity, descriptions of well-known functions and structures are omitted from the following description.

In the technical solutions of this disclosure, the collection, storage, usage, processing, transmission, provision and disclosure of private information of users are all carried out with the consent of the users, and are comply with the provisions of relevant laws and regulations, and do not violate public order and good customs.

In order to achieve desirable performances of a large model in various tasks, it is usually necessary to use a large number of text training samples to fine-tune the model. One text training sample may include a combination of a prompt and a response, i.e., <Prompt, Response>. The prompt represents a user input, i.e., a query is encapsulated into an instruction that interacts with a large model, and the response can be obtained by requesting the prompt to the large model. The response is an output of the large model and can be displayed to the user as a final result after further processing of the system.

In the related art, the query can be manually written and input into any online large model as a prompt to obtain a corresponding response output by the large model. By combining each prompt with its corresponding response, at least two text training samples are obtained.

However, because the original query input into the large model is written manually, and people's vision and capability are limited, a diversity of text training samples generated based on the response output by the large model is poor, and thus a generalization of the large model fine-tuned based on such text training samples is low.

In order to generate diversified text training samples and improve the generalization of the large model fine-tuned based on the text training samples, the embodiments of this disclosure proposes a method for generating a text training sample based on a large model, an apparatus and an electronic device.

The method for generating a text training sample based on a large model, the apparatus and the electronic device according to the embodiments of the disclosure are described below with reference to the attached drawings.

It should be noted that an execution subject of the method for generating a text training sample based on a large model in this embodiment is the apparatus for generating a text training sample based on a large model. In the following embodiments, the apparatus for generating a text training sample based on a large model will be referred to as a generating apparatus for short. The generating apparatus can be implemented by a hardware and/or software, and can be configured in an electronic device. The electronic device includes, but is not limited to, terminals, servers and the like.

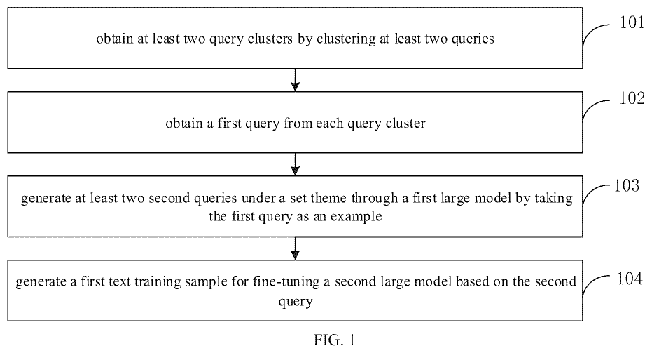

FIG. 1 is a flowchart of a method for generating a text training sample based on a large model according to an embodiment of the disclosure.

As illustrated in FIG. 1, the method for generating the text training sample based on the large model includes the following steps.

At step 101, at least two query clusters are obtained by clustering at least two queries.

The at least two queries are obtained by a generating apparatus in various public, legal and compliant ways. For example, the at least two queries can be obtained from a public data set or from a user after being authorized by the user.

The at least two queries can be different in any or at least two aspects of: a character length, a core word, a theme, a field, an intention, a sentence structure, and a grammatical feature, thus the at least two queries can be divided into different query clusters.

For example, at least two queries in the field of science and technology, education, entertainment or health can be obtained. For example, in the health field, queries related to the theme of fitness planning, sleep quality improving, diet planning or the like can be obtained. The sentence structures and/or grammatical features of queries under the same theme or different themes can be the same or different. For example, the queries can be “How to make a scientific and reasonable fitness plan to keep healthy?”, “To what extent does sleep affect health?”, or “Help me make a healthy recipe”.

A way to cluster the at least two queries can be any one of the related technologies, such as K-means clustering, K-medoids clustering, agglomerate hierarchical clustering, density-based clustering and so on. Taking K-means clustering as an example, a value of K can be pre-set to an integer greater than or equal to 2, and then the at least two queries are clustered by using the way of K-means clustering to obtain K query clusters.

In the at least two query clusters are obtained by clustering the at least two queries, the queries in the same query cluster have high similarity, while the queries in different query clusters are quite different in any or at least two aspects of: the character length, the core word, the theme, the filed, the intention, the sentence structure, and the grammatical feature.

At step 102, a first query is obtained from each query cluster.

The number of first queries obtained from each query cluster can be set as required, such as one or at least two, and the number of first queries obtained from different query clusters can be the same or different, which is not limited in this disclosure.

At step 103, at least two second queries under a set theme are generated through a first large model by taking the first query as example.

In a possible implementation, the first queries obtained from at least two query clusters can be taken as examples, to generate at least two second queries under the set theme via the first large model.

The first large model can be any large model. The large model is a large-scale neural network model trained using a deep learning algorithm to understand and generate natural language texts. The large model can capture the complexity and nuances of language after training using a large number of text data, so as to perform various natural language processing tasks, such as text generation, question and answer system, semantic understanding and reasoning. The design purpose of this model is to improve the expressive ability and predictive performance of the model, to prepare the model for processing more complex tasks and data, and to show human-like intelligence. The large model may include, for example, Generative Pre-trained Transformer 3 (GPT3), GPT4, Text-to-Text Transfer Transformer (T5), Large Language Model Meta AI (LLaMA), lightweight large models or the like.

The set theme can be set as required and may include one theme or at least two themes.

The number of second queries generated by the first large model can be set in advance.

For example, it is assumed that the set theme includes the theme of improving sleep health, and it is preset that 30 second queries are generated by the first large model. It is assumed that 3 query clusters are obtained by clustering 50 queries, and a query A is obtained from a query cluster 1, a query B is obtained from a query cluster 2, and a query C is obtained from a query cluster 3. Then the first large model can be requested to take the query A, the query B and the query C as examples to generate 30 second queries under the theme of improving sleep health.

When the first large model generates the 30 second queries under this theme, the first queries as examples are obtained from the 3 query clusters respectively, and the first queries obtained from different query clusters are different, so that the 30 second queries generated by the first large model are also different, that is, diversified.

In a possible implementation, steps 102-103 can be performed at least twice. That is, the first query is obtained from each query cluster at least twice, and the first queries obtained from at least two query clusters each time are taken as examples to generate at least two second queries under the set theme through the first large model, so that the number of second queries with differences is larger.

At step 104, a first text training sample for fine-tuning a second large model is generated based on the second query.

In a possible implementation, the first text training samples can be generated based on the at least two second queries under the set theme generated by the first large model.

The second large model can be any large model. The second large model and the first large model may be the same large model or different large models.

In a possible implementation, for each second query, the second query can be taken as a prompt and input into any online large model to obtain a response corresponding to the prompt through the large model, and the prompt is combined with the corresponding response to obtain one first text training sample.

According to the method for generating a text training sample based on a large model provided by the embodiment of the disclosure, at least two query clusters are obtained by clustering at least two queries, and a first query is obtained from each query cluster. At least two second queries under a set theme are generated via a first large model by taking the first query as an example. A first text training samples for fine-tuning a second large model is generated based on the second query. Because the first large model takes the first queries obtained from each query cluster as examples when generating the at least two second queries under the set theme, and the first queries obtained from different query clusters are different, the at least two second queries under the set theme generated by the first large model are also different. In other words, the at least two generated second queries are diversified. The first text training samples are generated based on the diversified second queries, which thus improves the diversity of the generated first text training samples. The second large model is fine-tuned based on the generated first text training samples, the generalization of the fine-tuned second large model can be improved.

In order to clearly explain the process of generating the at least two second queries under the set theme via the first large model and the process of generating the first text training samples for fine-tuning the second large model based on the second queries, the embodiment of the disclosure also provides a method for generating a text training sample based on an a large model.

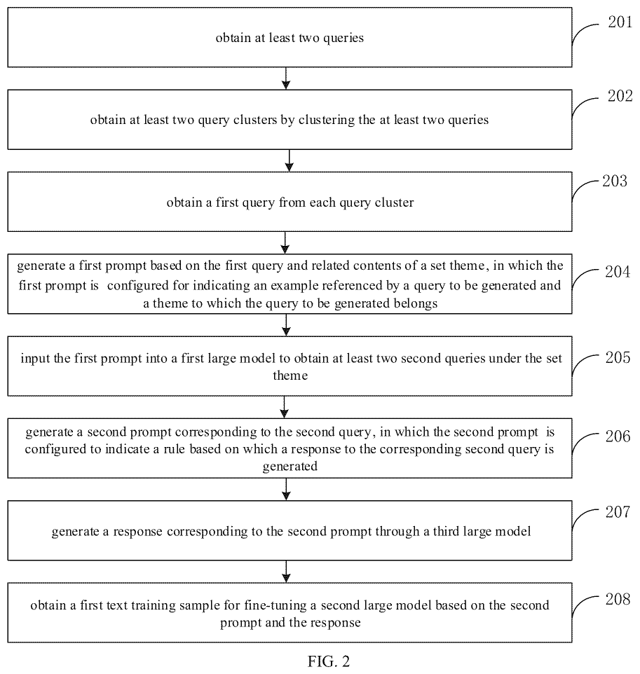

FIG. 2 is a flowchart of a method for generating a text training sample based on a large model according to another embodiment of the disclosure.

As illustrated in FIG. 2, the method for generating a text training sample based on a large model includes the following steps.

At step 201, at least two queries are obtained.

In a possible implementation, the at least two queries can be obtained in at least one of the following ways:
in response to a second large model being online, collecting historical queries input into the second large model to obtain the at least two queries;
obtaining a network file, dividing the network file into at least two fragments, and obtaining the at least two queries based on the at least two fragments, in which one fragment can be taken as one query; or
obtaining the at least two queries input manually.

The network file is a file published on the network.

The second large model is a large model to be fine-tuned.

In a possible implementation, in a case where the second large model to be fine-tuned is online, historical queries input into the second large model can be collected to obtained the at least two queries. in a case where the second large model is not online and in a cold start stage, the at least two queries input manually can be obtained, and/or the network file can be obtained and divided into at least two fragments, at least two queries can be obtained bases on the at least two fragments.

Therefore, it is possible to flexibly select an appropriate way to obtain the at least two queries, so that the obtained at least two queries are different in one aspect or at least two aspects. In addition, the at least two queries are obtained by collecting historical queries input to the online second large model, and the first text training samples for fine-tuning the second large model are then generated based on the at least two queries. It can automatically fine tune the second large model based on the user input data of the online launched model. In this way, the second large model can be continuously iterated and optimized based on the user input data, so as to continuously improve the generalization of the second large model.

At step 202, at least two query clusters are obtained by clustering the at least two queries.

At step 203, a first query is obtained from each query cluster.

At step 204, a first prompt is generated based on the first query and related contents of a set theme, in which the first prompt is configured for indicating an example referenced by a query to be generated and a theme to which the query to be generated belongs.

The related contents of the set theme can include a theme name, an introduction of the theme, etc.

In a possible implementation, the first prompt can be generated based on the first queries obtained from the at least two query clusters and the related contents of the set theme.

In a possible implementation, step 204 can be realized in the following ways:
obtaining a prompt template, in which the prompt template includes a first text to be replaced corresponding to the example referenced by the query to be generated and a second text to be replaced corresponding to the theme to which the query to be generated belongs; and
obtaining the first prompt by replacing the first text to be replaced based on the first query, and replacing the second text to be replaced based on the related contents of the set theme.

The first text to be replaced can be replaced based on at least two first queries.

The prompt template is a template for generating the first prompt, and contents in the prompt template can be set in advance as required. For example, the prompt template can be set to include texts to be replaced, such as the first text to be replaced corresponding to the example referenced by the query to be generated, and the second text to be replaced corresponding to the theme to which the query to be generated belongs, and the prompt template may also include indication information for indicating requirements satisfied by the query to be generated, such as the number of generated queries, a format of the output query, characters that cannot be included, and so on.

For example, the prompt template includes the following four paragraphs.

You are a query generator that can generate 30 diversified queries under a theme at one time with reference to the following example and based on the related contents of the theme, and return generated data in a list format that can be handled by Python:

The related contents of the theme include: the theme name is “name”, and the introduction includes “Introduction”;

The example includes: [“query”].

Please generate 30 diversified queries under the theme at one time with reference to the example and according to the related contents of the theme, in which at least 20 queries cannot contain the theme name and are inverted sentences, and the generated data should be returned in the list format.

Assuming that the related contents of the set theme include the theme name and the introduction of the set theme, after obtaining the prompt template, it can be determined that the first text to be replaced corresponding to the example referenced by the query to be generated in the prompt template is “query”, and the second texts to be replaced corresponding to the theme to which the query to be generated belongs are “name” and “Introduction”. Then, the first text query to be replaced “query” can be replaced by at least two first queries, the “name” in the second text to be replaced can be replaced by the theme name of the set theme, and the “Introduction” in the second text to be replaced can be replaced by the introduction of the set theme, and thus the first prompt is obtained.

Therefore, based on the preset prompt template, the first prompt for indicating the example referenced by the query to be generated and the theme to which the query to be generated belongs can be quickly generated.

It should be noted that in order to distinguish the prompt template for generating the first prompt from other prompt templates, the prompt template for generating the first prompt can be referred to as a first prompt template.

At step 205, the first prompt is input into a first large model to obtain at least two second queries under the set theme.

It is understood that by inputting the first prompt into the first large model, the first large model can generates, based on the first prompt, the at least two second queries under the set theme through its own capability by taking the first query in the first prompt as an example. Because when the first large model generates the at least two second queries under the set theme, the first queries taken as examples are obtained from at least two query clusters, and the first queries obtained from different query clusters are different, the at least two second queries under the set theme generated by the first large model are different, i.e., the at least two generated second queries are diversified.

Therefore, based on the first queries and the related contents of the set theme, the first prompt is generated. The first prompt is configured to indicate the example referenced by the query to be generated and the theme to which the query to be generated belongs. The first prompt is input into the first large model to obtain at least two second queries under the set theme, so that the first large model can be guided to understand task requirements more accurately through the first prompt and accurately generate the at least two second queries under the expected set theme based on the first queries and the related contents of the set theme.

At step 206, a second prompt corresponding to the second query is generated, in which the second prompt is configured to indicate a rule based on which a response to the corresponding second query is generated.

In a possible implementation, for each second query, a second prompt corresponding to the second query can be generated.

In a possible implementation, the second prompt corresponding to each second query can be generated in the following ways:
obtaining a second prompt template, in which the second prompt template includes a rule based on which a response to a specified query is generated and a third text to be replaced corresponding to the specified query; and
obtaining a second prompt by replacing the third text to be replaced based on the second query.

The second prompt template is a template for generating the second prompt, and contents in the second prompt template can be preset as required. For example, the second prompt template can be set to include a text to be replaced, such as the third text to be replaced corresponding to the specified query, and the second prompt template can also include the rule based on which the response to the specified query is generated, for example, which reference articles are used to generate the response, which constraints the response shall meet, the number of characters included in the response, and a format of the response.

For example, taking a knowledge question and answer task as an example, the second prompt template may include the following 10 paragraphs.

You are a content summarization assistant, give a user query and a list of reference articles, you should use the reference articles to answer the user query.

Answer constraints:
1. Any article in the list of reference articles unrelated to the query is directly ignored, and only articles that may be able to answer the query can be used as references. If there is no article in the list of reference articles that may be able to answer the user query, an answer will be “Sorry, there is no relevant information that has been retrieved”.
2. The answer needs to be output in three parts, with the answer output in a format of code and wrapped with “‘“ ”’”.

The first part is a brief summary, which can be summarized directly without the need to output a title like “brief summary”.

The second part includes at least two subtitles (e.g., ###2023 financial industry keywords) that match with an abstract, the abstract including 4-5 sentences can be directly output without the need to output any title such as “Part II” (Try to include as many points as possible, preferably, 5-6 points, but avoid to contain repeated information).

The third part presents reference links, that can answer the user query, used in a summary of the second part, starting with “###related resources”, and a title in the reference link is a title field in reference article information.

The following is the input, the answer shall be directly output and it should be noticed that a length of the answer does not exceed 2000 characters, and any analysis process does not be provided:
User query: {Query}
List of reference articles: {Docs}

After obtaining the second prompt template, the third text to be replaced corresponding to the specified query in the second prompt template is {Query}, then the third text to be replaced (i.e., {Query}) can be replaced with the second query, and the second prompt is thus obtained.

Therefore, based on the preset second prompt template, the second prompt for indicating the rule, based on which the response to the corresponding second query is generated, can be quickly generated.

At step 207, a response corresponding to the second prompt is generated through a third large model.

In a possible implementation, the response corresponding to each second prompt can be generated through the third large model.

The third large model can be any large model. The third large model and the second large model are different large models, and the third large model and the first large model can be the same large model or different large models.

In a possible implementation, for each second query, the second prompt corresponding to the second query is input into the third large model. The third large model can output one response corresponding to the second query, i.e. one response corresponding to the second prompt, based on the rule indicated by the second prompt.

In a possible implementation, for each second prompt, at least two corresponding responses can be generated through the third large model.

As an example, for each second prompt, at least two responses corresponding to the second prompt can be generated in the following way:
inputting the second prompt into at least two different third large models to obtain responses output by the at least two different third large models respectively.

In order to improve the accuracy of the generated responses, stronger large models can be used as the at least two different third large models, such as GPT4 and Gemini (which is a high-performance multimodal artificial intelligence model).

Therefore, at least two responses corresponding to the same second prompt can be generated quickly by directly through at least two different third large models.

As an example, for each second prompt, the at least two responses corresponding to the second prompt can be generated in the following ways:
generating the responses corresponding to the second prompt for multiple times through the third large model, in which the responses generated each time are different.

A response generated at the N^{th} time is an output obtained by inputting an updated prompt into the third large model, the updated prompt is obtained by splicing the second prompt with a response generated at the (N−1)^{th} time, and N is an integer greater than or equal to 2.

For each second prompt, the responses corresponding to the second prompt can be generated for multiple times through one or at least two third large models, and for the same third large model, the responses generated each time are different.

For example, at least two responses corresponding to a second prompt a can be generated via a third large model 1 and a third large model 2.

The second prompt a can be input into the third large model 1, and a response generated by the third large model 1 for the first time is obtained. The second prompt a is spliced with the response generated by the third large model 1 for the first time to obtain an updated prompt b. The updated prompt b is input into the third large model 1, and a response generated by the third large model 1 for the second time is obtained. The response generated for the second time is different from the response generated for the first time, and thus a total of two responses corresponding to the second prompt a can be generated twice through the third large model 1.

In addition, the second prompt a can be input into the third large model 2, and a response generated by the third large model 2 for the first time is obtained. The second prompt a is spliced with the response generated by the third large model 2 for the first time to obtain an updated prompt c. The updated prompt c is input into the third large model 2 to obtain a response generated by the third large model 2 for the second time. The response generated for the second time is different from the response generated for the first time, and thus a total of two responses corresponding to the second prompt a can be generated twice through the third large model 2.

As an example, assuming that the second prompt is XXXXXX, and the previously generated response is YYYYYY, the second prompt is spliced with the previously generated response to obtain an updated prompt, for example, the updated prompt may be:
XXXXXX, the previous response you reply is “YYYYYY”, please give a better answer to re-answer this question?

Therefore, the at least two responses corresponding to the same second prompt can be generated through at least one third large model, so that the number of third large models used in generating the responses corresponding to the second prompt can be reduced, and a generation cost of samples can be reduced.

At step 208, a first text training sample for fine-tuning a second large model is obtained based on the second prompt and the response.

In a possible implementation, any second prompt and any corresponding response can be combined as a candidate sample, so that at least one candidate sample can be obtained based on the same second prompt. For any candidate sample, based on a correlation between the second prompt and its corresponding response in the candidate sample and/or a quality of the response, a quality evaluation can be performed on the candidate sample to obtain a quality of the candidate sample. The quality can be represented by a quality score. In a case where one candidate sample corresponds to the same second prompt, if the quality score corresponding to the candidate sample is greater than a preset threshold, the candidate sample can be taken as a first text training sample, while if the quality score of the candidate sample is no greater than the preset threshold, the candidate sample can be discarded. In a case where at least two candidate samples corresponds to the same second prompt, the candidate sample with the highest quality score can be taken as a first text training sample, and other candidate samples corresponding to the second prompt can be discarded. Thus, the first text training sample for fine-tuning the second large model can be generated.

Specific implementations of steps 201-208 similar to those in other embodiments can refer to the detailed descriptions in other embodiments of the disclosure, and will not be described in detail here.

According to the embodiment of the disclosure, at least two query clusters are obtained by clustering at least two queries, and a first query is obtained from each query cluster. A first prompt is generated based on the first queries and related contents of a set theme, in which the first prompt is configured for indicating an example referenced by a query to be generated and a theme to which the query to be generated belongs. The first prompt is input into a first large model to obtain a second query, and a second prompt corresponding to the second query is generated, in which the second prompt is configured to indicate a rule based on which a response to the corresponding second query is generated. The response corresponding to the second prompt is generated through a third large model. The third large model is guided to understand the requirements of the task more accurately through the second prompt, accurately generate at least one expected response of the second prompt according to the generation rule of the response of the second query. Then the first text training sample for fine-tuning the second large model can be generated based on the second prompt and the corresponding response. In addition, when the first large model generates the at least two second queries under the set theme, the first queries obtained from each query cluster are taken as examples. Because the first queries obtained from different query clusters are different, the at least two second queries under the set theme generated by the first large model are different. In other words, the at least two generated second queries are diversified. Therefore, the first text training samples are generated based on the diversified second queries, which improves the diversity of the generated first text training samples. Moreover, the second large model is fine-tuned based on the generated first text training samples, so that the generalization of the fine-tuned second large model can be improved.

According to the above analysis, the embodiment of the disclosure can generate the first text training samples based on the second prompts and the corresponding responses. In order to improve a quality of the generated first text training sample, the embodiment of the disclosure further provides a method for generating a text training sample based on an a large model.

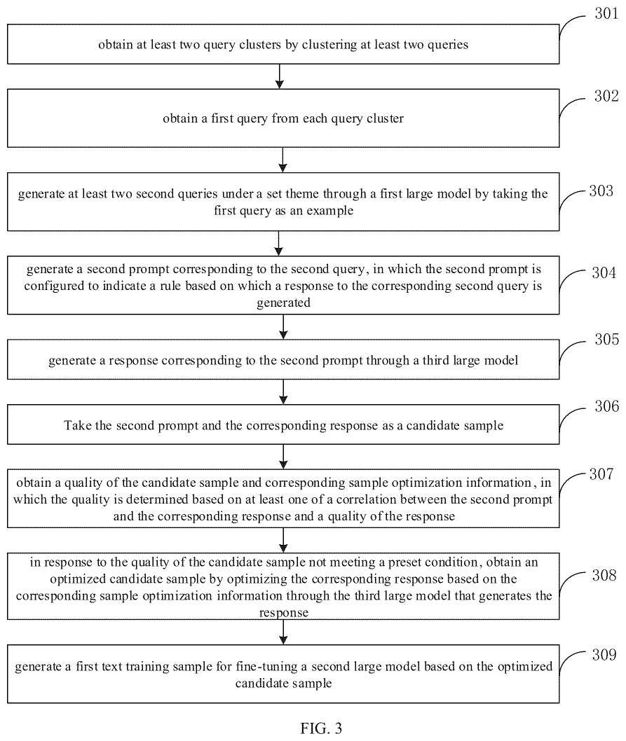

FIG. 3 is a flowchart of a method for generating a text training sample based on a large model according to another embodiment of the disclosure.

As illustrated in FIG. 3, the method for generating a text training sample based on a large model includes the following steps.

At step 301, at least two query clusters are obtained by clustering at least two queries.

At step 302, a first query is obtained from each query cluster.

At step 303, at least two second queries under a set theme are generated through a first large model by taking the first query as an example.

At step 304, a second prompt corresponding to the second query is generated, in which the second prompt is configured to indicate a rule based on which a response to the corresponding second query is generated.

At step 305, a response corresponding to the second prompt is generated through a third large model.

In a possible implementation, for each second query, the second prompt corresponding to the second query can be generated, and the response corresponding to the second prompt can be generated through the third large model.

At step 306, the second prompt and the corresponding response are taken as a candidate sample.

In a possible implementation, for each second prompt, a combination of the second prompt and one corresponding response can be taken as one candidate sample. Therefore, in a case where there is one response corresponding to the second prompt, one candidate sample corresponding to the second prompt can be obtained. In a case where there are at least two responses corresponding to the second prompt, at least two candidate samples corresponding to the second prompt can be obtained.

At step 307, a quality of the candidate sample and corresponding sample optimization information are obtained, in which the quality is determined based on at least one of a correlation between the second prompt and the corresponding response and a quality of the response.

The quality of any candidate sample is determined based on at least one of the correlation between the second prompt and the corresponding response in the candidate sample and the quality of the response.

The correlation between the second prompt and the corresponding response indicates a degree of correlation between the second prompt and the corresponding response. When the response is closely related to the second prompt, the response can accurately answer the query corresponding to the second prompt, or expand a topic of a conversation, the degree of correlation between the second prompt and the corresponding response is high. For example, assuming that the second prompt indicates a rule based on which a response to the corresponding query “How's the weather today” is generated, if the response corresponding to the second prompt is “Today is Monday”, because the second prompt belongs to the theme of “weather”, but the theme of the response is “date”, the two themes are different and the correlation between the second prompt and the corresponding response is low. If the response corresponding to the second prompt is “It's sunny today”, since the theme of the response is “weather”, which is the same as that of the second prompt, the correlation between the second prompt and the corresponding response is high.

The quality of the response can be determined by one or at least two factors of a clarity, a naturalness, an innovation and a richness of the response. The clarity indicates whether the response is clear and understandable, and whether a logic is coherent. The naturalness indicates whether the response is natural and smooth, and whether the response conforms to daily communication habits. The innovation indicates whether the response contains novel ideas or expressions. The richness indicates whether the content of the response is rich, such as whether the response is from at least two aspects, and whether the response includes at least two expression forms such as word and table.

The sample optimization information is information for optimizing the candidate sample, which may include, for example, defects of the candidate sample and optimization methods.

In a possible implementation, for any candidate sample, the quality of the candidate sample and the corresponding sample optimization information can be obtained in the following ways:
generating a corresponding third prompt based on the candidate sample, in which the third prompt is configured to indicate a rule based on which the quality of the candidate sample and the corresponding sample optimization information are generated; and
inputting the third prompt into a target evaluation model to obtain the quality of the candidate sample and the corresponding sample optimization information output by the target evaluation model.

The target evaluation model can be a large model in the related art or a model obtained by training an initial evaluation model. In order to improve an accuracy of the evaluation result, a strong large model can be used in the related art such as GPT3. In order to improve the training efficiency and reduce the training cost, the initial evaluation model can be a large model with fewer parameters, such as LLaMa model.

The quality of the candidate sample can be represented by a quality score.

In a possible implementation, a third prompt template can be obtained, which includes a rule based on which a quality of a specific sample is generated, a rule based on which corresponding sample optimization information is generated, and a fourth text to be replaced corresponding to the specific sample. The rule, based on which the quality of the specific sample is generated, and the rule, based on which the corresponding sample optimization information is generated, can be the same or different.

For example, the third prompt template may include the following four paragraphs.

The specified sample is: <prompt, response>

A quality evaluation rule is evaluating from aspects of a correlation between the prompt and the response, a clarity, a naturalness and an innovation of the response.

The rule for generating the sample optimization information is generating the sample optimization information of the specified sample from aspects of the correlation between the prompt and the response, the clarity, the naturalness and the innovation of the response.

What do you think of the quality score of this sample? What is the sample optimization information?

The prompt and response in the third prompt template are fourth texts to be replaced corresponding to the specified sample, the content of the second paragraph is the rule based on which the quality of the specified sample is generated, and the content of the third paragraph is the rule based on which the corresponding sample optimization information is generated.

After obtaining the third prompt template, the prompt in the fourth text to be replaced can be replaced with the second prompt in the candidate sample, and the response in the fourth text to be replaced can be replaced with the response in the candidate sample. In this way, the third prompt is obtained. The third prompt is configured to indicate the rule based on which the quality of the candidate sample and the corresponding sample optimization information are generated. By inputting the third prompt into the target evaluation model, the quality of the candidate sample and the corresponding sample optimization information output by the target evaluation model can be obtained.

Therefore, based on the candidate sample, a corresponding third prompt is generated. The third prompt is configured to indicate a rule based on which the quality of the candidate sample and the corresponding sample optimization information are generated. The third prompt is input into a target evaluation model to obtain the quality of the candidate sample and the corresponding sample optimization information output by the target evaluation model. The target evaluation model can be guided to understand the requirements of the task more accurately through the third prompt. Thus, the expected quality of candidate sample and the corresponding sample optimization information can be accurately generated based on the rule based on which the quality of the candidate sample and the corresponding sample optimization information are generated.

In a possible implementation, in the case that the target evaluation model is a model obtained by training an initial evaluation model, the initial evaluation model can be trained in the following ways to obtain the target evaluation model:
obtaining a fourth prompt corresponding to a target sample, in which the target sample includes a sample prompt corresponding to a sample query and a corresponding sample response, the sample prompt is configured for indicating a rule based on which the sample response to the corresponding sample query is generated, and the fourth prompt is configured for indicating a rule based on which a quality of the target sample and corresponding sample optimization information are generated;
inputting the fourth prompt into a fourth large model to obtain the quality of the target sample and the corresponding sample optimization information output by the fourth large model by; and
modifying the quality of the target sample and the corresponding sample optimization information, determining the fourth prompt annotated by the modified quality of the target sample and the modified corresponding sample optimization information as a second text training sample, and obtaining the target evaluation mode by training an initial evaluation model based on the second text training sample.

The fourth large model can be any large model. The fourth large model and the first, second or third large model may be the same or different large models. In order to improve the accuracy of the generated result, a strong large model may be used as the fourth large model.

There can be at least two target samples, in which one target sample is obtained by combining one sample prompt and the corresponding sample response. The methods for obtaining the sample query, the corresponding sample prompt and the corresponding sample response can be the same as the methods for obtaining the second query, the corresponding second prompt and the corresponding response, and the details are not repeated here.

The way to obtain the fourth prompt corresponding to the target sample can be the same as the way to obtain the third prompt corresponding to the candidate sample, and the details will not be repeated here.

In an example embodiment, the fourth prompt is input into the fourth large model, and the quality of the target sample and the corresponding sample optimization information output by the fourth large model can be obtained. The quality of the target sample and the corresponding sample optimization information are modified, for example, manually, and the modified quality of the target sample and the modified corresponding sample optimization information are taken as annotations of the corresponding fourth prompt, and the annotated fourth prompt is taken as a second text training sample. The target evaluation mode is obtained by training an initial evaluation model based on the second text training sample.

Therefore, by obtaining the fourth prompt corresponding to the target sample and inputting the fourth prompt into the fourth large model, the quality of the target sample and the corresponding sample optimization information output by the fourth large model are obtained. The quality of the target sample and the corresponding sample optimization information are modified, and the fourth prompt annotated by the modified quality of the target sample and the modified corresponding sample optimization information as a second text training sample is taken as the second text training sample to training the initial evaluation model, which can obtain the target evaluation model that can accurately predict the quality of the candidate sample and the corresponding sample optimization information.

At step 308, in response to the quality of the candidate sample not meeting a preset condition, an optimized candidate sample is obtained by optimizing the corresponding response based on the corresponding sample optimization information through the third large model that generates the response.

The quality of the candidate sample can be represented by a quality score. Correspondingly, the quality of the candidate sample does not meet the preset conditions, which can include that the quality score of the candidate sample is no greater than a preset threshold.

In a possible implementation, in a case where the quality of a candidate sample does not meet the preset condition, the response can be optimized based on the corresponding sample optimization information through the third large model that generates the response in the candidate sample, to obtain an optimized candidate sample.

In a possible implementation, for a candidate sample whose quality does not meet the preset condition, the optimized candidate sample can be obtained by optimizing the response in the following ways:
obtaining an optimized prompt by splicing the second prompt with the sample optimization information, in which the second prompt is a second prompt in the candidate sample whose quality does not meet the preset condition, and the sample optimization information is sample optimization information corresponding to the candidate sample;
obtaining an optimized response by inputting the optimized prompt into the third large model that generates the response, in which the response is a response in the candidate sample whose quality does not meet the preset condition; and
generating the optimized candidate sample based on the second prompt and the optimized response.

Assuming that the second prompt is “XXXXXX” and the sample optimization information is “******”, the optimized prompt can be, for example: Please response to “XXXXXX” based on the sample optimization information of “******”?

In an example embodiment, for any candidate sample, in a case where it is determined that the quality of the candidate sample does not meet the preset condition based on at least one of a correlation between the second prompt and the corresponding response and a quality of the response, the second prompt in the candidate sample can be spliced with the corresponding sample optimization information to obtain an optimized prompt. The optimized prompt is input into the third large model that generates the original response in the candidate sample. Because the sample optimization information can include defects of the candidate sample and optimization methods, the third large model can optimize the original response in consideration of the defects of the candidate sample and the optimization methods to obtain an optimized response. A combination of the second prompt and the optimized response can be taken as an optimized candidate sample. Therefore, the third large model can be used to optimize the candidate sample based on the sample optimization information of the candidate sample, so that a higher correlation between the second prompt and the corresponding response in the candidate sample or a higher quality of the response can be achieved, thereby improving the quality of the candidate sample.

At step 309, a first text training sample for fine-tuning a second large model is generated based on the optimized candidate sample.

It should be noted that for any candidate sample, after obtaining the optimized candidate sample, the quality of the optimized candidate sample and the corresponding optimization information can be obtained, and then it is determined whether the quality of the optimized candidate sample meets the preset condition, if not, the optimized candidate sample can be further optimized in the above manner until the quality of the optimized candidate sample meets the preset condition or the optimization process has been performed for a preset number of times.

In a possible implementation, for any second prompt, in a case that the second prompt corresponds to one candidate sample, if the quality of the candidate sample does not meet the preset condition, the candidate sample can be optimized based on the sample optimization information. After obtaining the optimized candidate sample, the quality of the optimized candidate sample and the corresponding optimization information are obtained. It is determined whether the quality of the optimized candidate sample meets the preset condition, if not, the current optimized candidate sample is further optimized in the above manner until the quality of the optimized candidate sample meets the preset condition, or the optimization process has been performed for a preset number of times. The last optimized candidate sample is taken as one first text training sample. If the quality of the candidate sample still does not meet the preset condition after at least two optimization processes, the candidate sample can be discarded.

In a possible implementation, for any second prompt, in a case that the second prompt corresponds to at least two candidate samples, the candidate sample whose quality does not meet the preset condition can be optimized based on the corresponding sample optimization information. After obtaining the optimized candidate sample, the quality of the optimized candidate sample and the corresponding optimization information are obtained. It is determined whether the quality of the optimized candidate sample meets the preset condition, if not, the optimized candidate sample is further optimized in the above way until the quality of the optimized candidate sample meets the preset condition or the optimization process has been performed for a preset number of times. The candidate sample with the highest quality is selected from the last optimized candidate sample and the candidate sample whose initial quality meet the preset condition as one first text training sample.

In an example embodiment, after generating enough first text training samples, the second large model can be fine-tuned incrementally, and the performance of the fine-tuned second large model can be evaluated. If the performance is not up to expectations, more first text training samples can be generated according to the method of the above embodiments, and then the model can be fine-tuned continuously through at least two rounds of training to continuously improve the capability of the model. After the fine-tuned second large model goes online, the historical queries that have been input into the second large model can be automatically obtained from a user log, and then the first text training samples are generated according to the above method and used to continuously update the second large model, thereby optimizing the user experience.

In a possible implementation, the above third prompt template may also include a rule based on which a difficulty value of a specified sample is generated, so that the third prompt obtained after replacing the response in the fourth text to be replaced with the response in the candidate sample is also configured to indicate a rule based on which a difficulty value of the candidate sample is generated. The difficulty value indicates a level of difficulty for generating the response.

For example, the rule based on which the difficulty value of the specified sample is generated includes determining the difficulty value from the following aspects: a number of fields or themes contained in the specified sample, whether it takes at least two rounds of interaction to give a response, and a quality score of the specified sample. In a case where there are a large number of fields or themes contained in the specified sample, it is considered that the difficulty value of the specified sample is high. In a case of requiring at least two rounds of interaction to give a response, it is considered that the difficulty value of the specified sample is high. The lower the quality score of the specified sample, the higher the difficulty value of the specified sample.

The third prompt is input into the target evaluation model, and the difficulty value of the candidate sample output by the target evaluation model can be obtained. After generating the first text training sample according to the candidate sample, the first text training sample corresponding to the candidate sample can be allocated, according to the difficulty value, to a target training stage in at least two training stages of the second large model. The difficulty value corresponding to the first text training sample adopted in different training stages is different.

For example, a stage of fine-tuning the second large model can be divided into three training stages, in which a first training stage can adopt the first text training sample with a lower difficulty value, a second training stage can adopt the first text training sample with a medium difficulty value, and a third training stage can adopt the first text training sample with a higher difficulty value. Based on the difficulty value, the first text training sample corresponding to the candidate sample is allocated into the target training stage among at least two training stages of the second large model, and the second large model is fine-tuned in the order of the first training stage, the second training stage and the third training stage, so that the second large model can gradually establish basic understandings and cognitive frameworks for tasks, accelerating the fine-tuning process and improving a model effect.

The specific implementations of steps 301-309 can be referred to the detailed descriptions in other embodiments of the disclosure, which will not be described in detail here.

In the method for generating a text training sample based on a large model according to the embodiment of the disclosure, the second prompt and the corresponding response are taken as the candidate sample. The quality of the candidate sample and the corresponding sample optimization information are obtained. The quality is determined based on at least one of the correlation between the second prompt and the corresponding response and the quality of the response. In a case where the quality of the candidate sample does not meet the preset condition, the response is optimized based on the corresponding sample optimization information by the third large model that generates the response, to obtain the optimized candidate sample. Based on the optimized candidate sample, the first text training sample for fine-tuning the second large model is generated, improving the quality of the candidate sample, so that a large number of candidate samples will not be filtered out because their quality do not meet the preset condition, which improves a sample pass rate, reduces a sample generation cost, thereby achieving a better effect of the second large model fine-tuned based on the first text training sample.

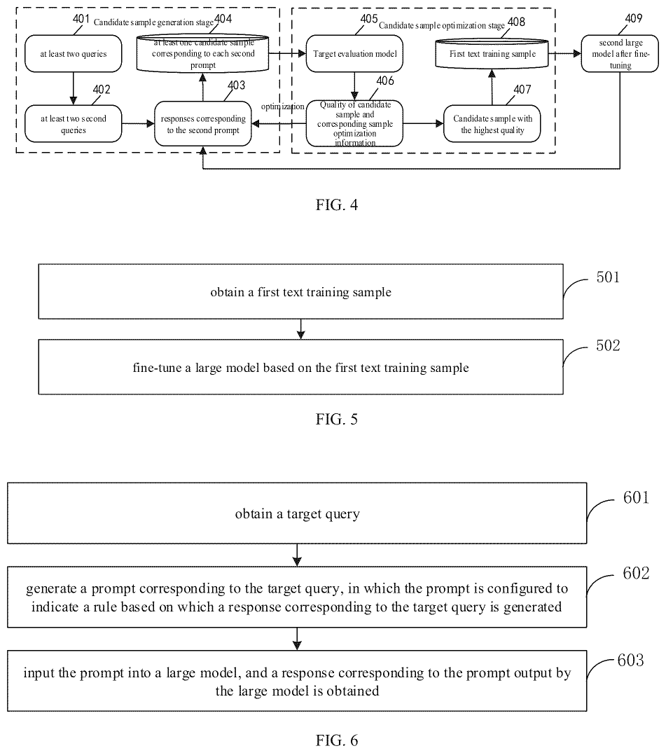

FIG. 4 is a flowchart of a method for generating a text training sample based on a large model according to the embodiment of the disclosure, the method is illustrated in the embodiment as an example.

As illustrated in FIG. 4, the method for generating a text training sample based on a large model includes two stages: a candidate sample generation stage and a candidate sample optimization stage.

In the candidate sample generation stage, at least two queries can be obtained (in block 401), and at least two queries are clustered to obtain at least two query clusters. A first query is obtained from each query cluster. Taking the first query as an example, at least two second queries under a set theme are generated through a first large model. In this way, the at least two second queries are generated (in block 402). For each second query, a second prompt corresponding to the second query can be generated, in which the second prompt is configured to indicate a rule based on which a response to the corresponding second query is generated. The response corresponding to the second query is generated through a third large model (in block 403). For each second prompt, the second prompt and one corresponding response can be taken as a candidate sample, and at least one candidate sample corresponding to the second prompt can be obtained (in block 404).

In the candidate sample optimization stage, a target evaluation model can be obtained (in block 405). For any candidate sample, a quality of the candidate sample and corresponding sample optimization information are obtained based on the target evaluation model (in block 406). In a case where the quality of the candidate sample does not meet a preset condition, an optimized candidate sample is obtained by optimizing the response based on the corresponding sample optimization information by the third large model that generates the response in the candidate sample. The quality of the optimized candidate sample and the corresponding optimization information can be continuously obtained through the target evaluation model, until the quality of the optimized candidate sample meets the preset condition, or the optimization process has been performed for a preset number of times. For any second prompt, the candidate sample with the highest quality can be selected as a first text training sample from the last optimized candidate sample and the first candidate sample whose initial quality meets the preset condition (in block 407). Thus, a first text training sample for fine-tuning a second large model can be obtained (in block 408). Through the first text training sample, the second large model can be fine-tuned to obtain the fine-tuned second large model (in block 409). The performance of the fine-tuned second large model is evaluated, if the performance of the fine-tuned second large model is not up to expectations, more first text training samples can be generated according to the above method. Based on the first text training samples generated, the model can be continued to be fine-tuned, and the capability of the model can be continuously improved after at least two rounds of training.

After the fine-tuned second large model goes online, the historical queries input into the second large model can be automatically obtained from a user log. Then the first text training sample is generated according to the above method, and the second large model is continuously updated, thereby optimizing the user experience. The fine-tuned second large model can be used in block 403 to continue to generate the response corresponding to the second prompt, so as to further generate the first text training sample and continue to fine-tune the model.

Therefore, when the first large model generates at least two second queries under the set theme, the first query obtained from each query cluster is taken as an example, and the first queries obtained from different query clusters are different, so the at least two second queries under the set theme generated by the first large model are also different. That is, the at least two generated second queries are diversified. Therefore, the first text training samples are generated based on the diversified second queries, a diversity of the generated first text training samples is improved. By fine-tuning the second large model based on the generated first text training samples, a generalization of the fine-tuned second large model is improved. In a case where the quality of the candidate sample does not meet the preset condition, the third large model that generates the response in the candidate sample optimizes the response based on the corresponding sample optimization information to obtain an optimized candidate sample. The first text training samples for fine-tuning the second large model are generated based on the optimized candidate sample, so that the quality of the candidate sample can be improved. Therefore, a large number of candidate samples will not be filtered out because their quality do not meet the preset condition, which improves a sample pass rate, reduces a sample generation cost, thereby achieving a better effect of the second large model fine-tuned based on the first text training sample. After the fine-tuned second large model goes online, the historical queries input into the second large model are automatically obtained from the user log, and then the first text training samples are generated according to the above method, based on which the second large model is continuously updated, so that it can automatically and efficiently generate the first text training samples according to the user input data of the online second large model without manual intervention, and automatically fine-tune the second large model, to continuously iterate and optimize the second large model based on the user input data of the second large model, thereby continuously improving the generalization of the second large model.

Based on the first text training samples generated in the above embodiments, the disclosure also provides a method for fine-tuning a large model.

It should be noted that an execution subject of the method for fine-tuning a large model in this embodiment is an apparatus for fine-tuning a large model, which can be implemented by software and/or hardware and can be configured in an electronic device. The electronic device includes, but is not limited to, a terminal, a server and the like.

FIG. 5 is a flowchart for a method for fine-tuning a large model according to an embodiment of the disclosure.

As illustrated in FIG. 5, the method for fine-tuning a large model includes the following steps.

At step 501, a first text training sample is obtained.

The first text training sample is generated based on the method for generating the text training sample on the large model in the above embodiments.

At step 502, a large model is fine-tuned based on the first text training sample.

The large model may be the second large model in the above embodiments.

The way to fine-tune the large model can be set as needed.

In a possible implementation, the large model can be incrementally fine-tuned based on the obtained first text training samples, and the performance of the fine-tuned large model is evaluated. If the performance of the fine-tuned large model is not up to expectations, more first text training samples can be generated according to the method for generating the text training sample based on the large model in the above embodiments. Based on the first text training samples generated, the model can be further fine-tuned, and thus the ability of the large model can be continuously improved after at least two rounds of training. After the fine-tuned large model goes online, the historical queries input into the large model can be automatically obtained from the user log, and the first text training samples are then generated according to the method for generating the text training sample based on the large model in the above embodiments, so as to continuously update the large model and optimize the user experience.

According to the method for fine-tuning the large model provided by the embodiment of the disclosure, the first text training samples are obtained. The first text training samples are generated based on the method for generating the text training sample based on the large model in the above embodiments, and the large model is then fine-tuned based on the first text training samples. Because the first text training samples are diversified, the large model is fine-tuned based on the first text training samples, improving the generalization of the fine-tuned large model.

Based on the above embodiments, the disclosure further provides a question and answer method based on a large model.

It should be noted that an execution subject of the question and answer method based on a large model in this embodiment is a question and answer apparatus based on a large model, which can be implemented by software and/or hardware and can be configured in an electronic device. The electronic device includes, but is not limited to, a terminal, a server and the like.

FIG. 6 is a flowchart for a question and answer method based on a large model according to an embodiment of the disclosure.

As illustrated in FIG. 6, the question and answer method based on the large model includes the following steps.

At step 601, a target query is obtained.

The target query can be any query proposed by a user, e.g., “I'm going on a business trip” or “To what extent does sleep affect health?”.

At step 602, a prompt corresponding to the target query is generated, in which the prompt is configured to indicate a rule based on which a response corresponding to the target query is generated.

In a possible implementation, the prompt corresponding to the target query can be generated in the following ways:
obtaining a fourth prompt template, in which the fourth prompt template includes a rule based on which a response to a specified query is generated and a fifth text to be replaced corresponding to the specified query; and
obtaining the prompt corresponding to the target query by replacing the fifth text to be replaced based on the target query.

The fourth prompt template is configured to generate the prompt corresponding to the target query, and contents in the fourth prompt template can be preset as required. For example, the fourth prompt template can be set to include a text to be replaced, such as the fifth text to be replaced corresponding to the specified query, and the fourth prompt template can also be set to include a rule based on which the response to the specified query is generated, such as which reference articles are used to generate the response, which constraints the response shall meet, the number of characters included in the response, and a format of the response.

For example, taking a knowledge question and answer task as an example, the fourth prompt template may include the following 10 paragraphs.

You are a content summarization assistant, give a user query and a list of reference articles, you should use the reference articles to answer the user query.

Answer constraints:
1. Any article in the list of reference articles unrelated to the query is directly ignored, and only articles that may be able to answer the query can be used as references. If there is no article in the list of reference articles that may be able to answer the user query, an answer will be “Sorry, there is no relevant information that has been retrieved”.
2. The answer needs to be output in three parts, with the answer output in a format of code and wrapped with “‘“ ”’”.

The first part is a brief summary, which can be summarized directly without the need to output a title like “brief summary”.

The second part includes at least two subtitles (e.g., ###2023 financial industry keywords) that match with an abstract, the abstract including 4-5 sentences can be directly output without the need to output any title such as “Part II” (Try to include as many points as possible, preferably, 5-6 points, but avoid to contain repeated information).

The third part presents reference links, that can answer the user query, used in a summary of the second part, starting with “###related resources”, and a title in the reference link is a title field in reference article information.

The following is the input, the answer shall be directly output and it should be noticed that a length of the answer does not exceed 2000 characters, and any analysis process does not be provided:
User query: {Query}
List of reference articles: {Docs}

After obtaining the fourth prompt template, the fifth text to be replaced corresponding to the specified query in the fourth prompt template is {Query}, and the fifth text to be replaced (i.e., {Query}) can be replaced with the target query, and the prompt corresponding to the target query is thus obtained.

Taking a function component recall task as an example, the fourth prompt template may include the following 8 paragraphs.

You need to perform an intention orchestration on the query input by the user and output a result of intention orchestration in list form, to ensure that an order of intentions in the list is logical (if the intention is not in the following list, an empty list will be output).

Intention list:
[Travel Application Plug-in]: screening out a list of events to be completed based on information such as time, priority and completion status.
[Meal Card Recharge]: returning to a link of meal card recharge for the current user.
[Leave Application]: initiating an annual leave application for the current user, including a start time and an end time of the leave.

The output result is in the following format:
[“Intention 1”, “Intention 2”]
User Query: {Query}.

After obtaining the fourth prompt template, the fifth text to be replaced corresponding to the specified query in the fourth prompt template can be determined to be {Query}, the fifth text to be replaced (i.e., {Query}) can be replaced with the target query, and the prompt corresponding to the target query can thus be obtained.

Therefore, based on the preset fourth prompt template, the prompt for indicating the rule, based on which the response to the corresponding target query is generated, can be quickly generated.

At step 603, the prompt is input into a large model, and a response corresponding to the prompt output by the large model is obtained.

The large model is a large model fine-tuned based on the first text training samples, and the first text training samples are generated based on the method for generating the text training sample based on the large model in the above embodiments.

For another example, assuming that the prompt is generated based on the fourth prompt template corresponding to the question and answer task, the prompt is input into the large model, and the large model can summarize the list of reference articles based on the prompt to generate the response corresponding to the prompt. The response can answer the target query.

Assuming that the prompt is generated based on the fourth prompt template corresponding to the function component recall task, the prompt is input into the large model, and the large model can perform the intention orchestration on the target query based on the prompt, and output the result of the intention orchestration in the list form. The result of the intention orchestration can be configured to recall the corresponding function components from the existing function components.

In the question and answer method based on the large model provided by the embodiment of the disclosure, a target query is obtained to generate a prompt corresponding to the target query. The prompt is configured to indicate a rule based on which a response corresponding to the target query is generated. The prompt is input into the large model, and the response corresponding to the prompt output by the large model is obtained. The large model is a large model fine-tuned by the first text training samples. The first text training samples are generated based on the method for generating the text training sample based on the large model in the above embodiments. Because the first text training samples are diversified, the generalization of the large model fine-tuned based on the first text training samples can be improved, and an accuracy of the answer to the target query can be improved based on the fine-tuned large model.

In order to implement the above embodiments, the disclosure also provides an apparatus for generating a text training sample based on a large model.

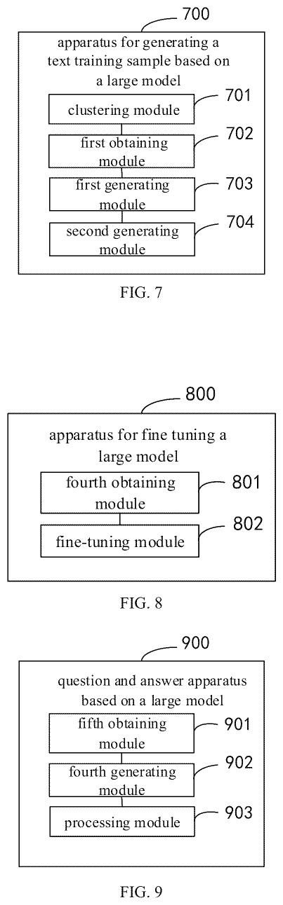

FIG. 7 is a schematic diagram of an apparatus for generating a text training sample based on a large model provided by an embodiment of the disclosure.

As illustrated in FIG. 7, the apparatus 700 for generating a text training sample based on a large model includes:
a clustering module 701, configured to obtain at least two query clusters by clustering at least two queries;
a first obtaining module 702, configured to obtain a first query from each query cluster;
a first generating module 703, configured to generate at least two second queries under a set theme via a first large model by taking the first query as an example; and
a second generating module 704, configured to generate a first text training sample for fine-tuning a second large model based on the second query.

As a possible implementation of the embodiment of the disclosure, the first generating module 703 includes:
a first generating sub-module, configured to generate a first prompt based on the first query and related contents of the set theme, in which the first prompt is configured for indicating an example referenced by a query to be generated and a theme to which the query to be generated belongs; and
a processing sub-module, configured to obtain the second query by inputting the first prompt into the first large model.

As a possible implementation of the embodiment of the disclosure, the first generating sub-module includes:
a first obtaining unit, configured to obtain a prompt template, in which the prompt template includes a first text to be replaced corresponding to the example referenced by the query to be generated and a second text to be replaced corresponding to the theme to which the query to be generated belongs; and
a replacing unit, configured to obtain the first prompt by replacing the first text to be replaced based on the first query, and replacing the second text to be replaced based on the related contents of the set theme.

As a possible implementation of the embodiment of the disclosure, the second generating module 704 includes:
a second generating sub-module, configured to generate a second prompt corresponding to the second query, in which the second prompt is configured to indicate a rule based on which a response to the corresponding second query is generated;
a third generating sub-module, configured to generate a response corresponding to the second prompt via a third large model; and
a fourth generating sub-module, configured to generate a first text training sample based on the second prompt and the response.

As a possible implementation of the embodiment of the disclosure, each of the second prompt corresponds to at least two responses, the third generating sub-module includes:
a first generating unit, configured to input the second prompt into at least two different third large models to obtain responses output by the at least two different third large models respectively.

As a possible implementation of the embodiment of the disclosure, each of the second prompt corresponds to at least two responses, the third generating sub-module includes:
a second generating unit, configured to generate the responses corresponding to the second prompt for multiple times via the third large model, in which the responses generated at each time are different,
in which a response generated at the N^{th} time is an output obtained by inputting an updated prompt into the third large model, the updated prompt is obtained by splicing the second prompt with a response generated at the (N−1)^{th} time, and N is an integer greater than or equal to 2.

As a possible implementation of the embodiment of the disclosure, the fourth generating sub-module includes:
a determining unit, configured to take the second prompt and the corresponding response as a candidate sample;
a second obtaining unit, configured to obtain a quality of the candidate sample and corresponding sample optimization information, in which the quality is determined based on at least one of a quality of the response and a correlation between the second prompt and the corresponding response; and
an optimizing unit, configured to, in response to the quality of the candidate sample not meeting a preset condition, obtain an optimized candidate sample by optimizing the response based on the corresponding sample optimization information through the third large model that generates the response; and
a third generating unit, configured to generate the first text training sample based on the optimized candidate sample.

As a possible implementation of the embodiment of the disclosure, the second obtaining unit includes:
a first generating sub-unit, configured to generate a corresponding third prompt based on the candidate sample, wherein the third prompt is configured to indicate a rule based on which the quality of the candidate sample and the corresponding sample optimization information are generated; and a second generating sub-unit, configured to input the third prompt into a target evaluation model to obtain the quality of the candidate sample and the corresponding sample optimization information output by the target evaluation model.

As a possible implementation of the embodiment of the disclosure, the apparatus 700 further includes:
a second obtaining module, configured to obtain a fourth prompt corresponding to a target sample, in which the target sample comprises a sample prompt corresponding to a sample query and a corresponding sample response, the sample prompt is configured for indicating a rule based on which the sample response to the corresponding sample query is generated, and the fourth prompt is configured for indicating a rule based on which a quality of the target sample and corresponding sample optimization information are generated;
a third generating module, configured to input the fourth prompt into a fourth large model to obtain the quality of the target sample and the corresponding sample optimization information output by the fourth large mode; and
a modifying module, configured to modify the quality of the target sample and the corresponding sample optimization information; and
a training module, configured to determine the fourth prompt annotated by the modified quality of the target sample and the modified corresponding sample optimization information as a second text training sample, and obtain the target evaluation mode by training an initial evaluation model based on the second text training sample.

As a possible implementation of the embodiment of the disclosure, the optimizing unit includes:
a splicing sub-unit, configured to obtain an optimized prompt by splicing the second prompt with the sample optimization information;
a third generating sub-unit, configured to obtain an optimized response by inputting the optimized prompt into the third large model that generates the response; and
a fourth generating sub-unit, configured to generate the optimized candidate sample based on the second prompt and the optimized response.

As a possible implementation of the embodiment of the disclosure, the third obtaining module obtains the at least two queries in at least one of the following ways:
in response to the second large model being online, collecting historical queries input into the second large model to obtain the at least two queries;
obtaining a network file, dividing the network file into at least two fragments, and obtaining the at least two queries based on the at least two fragments; or
obtaining the at least two queries input manually.

It should be noted that the above explanation of the method for generating a text training sample based on a large model is also applicable to the apparatus for generating a text training sample based on a large model of this embodiment, and will not be repeated here.

In order to realize the above embodiments, the disclosure also provides an apparatus for fine tuning a large model.

FIG. 8 is a schematic diagram of an apparatus for fine tuning a large model provided by an embodiment of the disclosure.

As illustrated in FIG. 8, the apparatus 800 for fine tuning a large model includes:
a fourth obtaining module 801, configured to obtain a first text training sample, wherein the first text training sample is generated based on the method of any one of claims 1-11; and
a fine-tuning module 802, configured to fine-tune a large model based on the first text training sample.

It should be noted that the above explanation of the method for fine tuning the large model is also applicable to the apparatus for fine tuning the large model of this embodiment, and will not be repeated here.

In order to realize the above embodiments, the disclosure also provides a question and answer apparatus based on a large model.

FIG. 9 is a schematic diagram of a question and answer apparatus based on a large model provided by an embodiment of the disclosure.

As illustrated in FIG. 9, the question and answer apparatus 900 based on a large model includes:
a fifth obtaining module 901, configured to obtain a target query;
a fourth generating module 902, configured to generate a prompt corresponding to the target query, in which the prompt is configured to indicate a rule based on which a response corresponding to the target query is generated; and
a processing module 903, configured to obtain a response corresponding to the prompt output by a large model by inputting the prompt into the large model, in which the large model is a large model fine-tuned by using a first text training sample, and the first text training sample is generated based on the method for generating a text training sample based on a large model.

It should be noted that the above explanation of the question and answer method based on the large model is also applicable to the question and answer apparatus based on the large model of this embodiment, and will not be repeated here.

According to the embodiments of the disclosure, the disclosure also provides an electronic device, a readable storage medium and a computer program product.

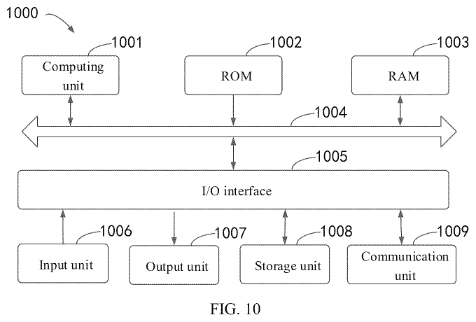

FIG. 10 is a schematic block diagram of an exemplary electronic device 1000 that can be used to implement embodiments of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown here, their connections and relations, and their functions are merely examples, and are not intended to limit the implementations of the disclosure described and/or required herein.

As illustrated in FIG. 10, the electronic device 1000 includes a computing unit 1001 for performing various appropriate actions and processes based on computer programs stored in a Read-Only Memory (ROM) 1002 or computer programs loaded from a storage unit 1008 to a Random Access Memory (RAM) 1003. In the RAM 1003, various programs and data required for the operation of the electronic device 1000 are stored. The computing unit 1001, the ROM 1002, and the RAM 1003 are connected to each other through a bus 1004. An input/output (I/O) interface 1005 is also connected to the bus 1004.

Components in the electronic device 1000 are connected to the I/O interface 1005, including: an input unit 1006, such as a keyboard, a mouse; an output unit 1007, such as various types of displays, speakers; a storage unit 1008, such as a disk, an optical disk; and a communication unit 1009, such as network cards, modems, and wireless communication transceivers. The communication unit 1009 allows the electronic device 1000 to exchange information/data with other devices through a computer network such as the Internet and/or various telecommunication networks.

The computing unit 1001 may be various general-purpose and/or dedicated processing components with processing and computing capabilities. Some examples of the computing unit 1001 include, but are not limited to, a Central Processing Unit (CPU), a Graphics Processing Unit (GPU), various dedicated Artificial Intelligence (AI) computing chips, various computing units that run machine learning (ML) model algorithms, a Digital Signal Processor (DSP), and any appropriate processor, controller and microcontroller. The computing unit 1001 executes the various methods and processes described above, such as the method for generating a text training sample based on a large model, the method for fine-tuning a large model, and a question and answer method based on a large model. For example, in some embodiments, the above methods may be implemented as a computer software program, which is tangibly contained in a machine-readable medium, such as the storage unit 1008. In some embodiments, part or all of the computer programs may be loaded and/or installed on the electronic device 1000 via the ROM 1002 and/or the communication unit 1009. When the computer program is loaded on the RAM 1003 and executed by the computing unit 1001, one or more steps of each of the method for generating a text training sample based on a large model, the method for fine-tuning a large model, and a question and answer method based on a large model may be executed. Alternatively, in other embodiments, the computing unit 1001 may be configured to perform the method for generating a text training sample based on a large model, the method for fine-tuning a large model, and a question and answer method based on a large model in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These various implementations may be implemented in one or more computer programs, the one or more computer programs may be executed and/or interpreted on a programmable system including at least one programmable processor, which may be a dedicated or general programmable processor for receiving data and instructions from a storage system, at least one input apparatus and at least one output apparatus, and transmitting the data and instructions to the storage system, the at least one input apparatus and the at least one output apparatus.

The program code configured to implement the methods of the disclosure may be written in any combination of one or more programming languages. These program codes may be provided to the processors or controllers of general-purpose computers, dedicated computers, or other programmable data processing apparatuses, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, RAMS, ROMs, Electrically Programmable Read-Only-Memories (EPROM), flash memories, fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display apparatus (e.g., a Cathode Ray Tube (CRT) or a Liquid Crystal Display (LCD) monitor for displaying information to a user); and a keyboard and pointing apparatus (such as a mouse or trackball) through which the user can provide input to the computer. Other kinds of apparatuses may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and Virtual Private Server (VPS) services. The server may be a server of a distributed system, or a server combined with a block-chain.

It is noted that AI is a subject that causes computers to simulate certain thinking processes and intelligent behaviors (such as learning, reasoning, thinking and planning) of human beings, which covers both hardware-level technologies and software-level technologies. The AI hardware technologies generally include technologies such as sensors, dedicated AI chips, cloud computing, distributed storage, and big data processing. The AI software technologies generally include several major aspects such as computer vision technology, speech recognition technology, natural language processing technology, learning/deep learning, big data processing technology and knowledge graph technology.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for generating a text training sample based on a large model, comprising:
obtaining at least two query clusters by clustering at least two queries;
obtaining a first query from each query cluster;
generating at least two second queries under a set theme through a first large model by taking the first query as an example; and
generating a first text training sample for fine-tuning a second large model based on the second query.

2. The method of claim 1, wherein generating the at least two second queries under the set theme through the first large model by taking the first query as the example, comprises:
generating a first prompt based on the first query and related contents of the set theme, wherein the first prompt is configured for indicating an example referenced by a query to be generated and a theme to which the query to be generated belongs; and
obtaining the second query by inputting the first prompt into the first large model.

3. The method of claim 2, wherein generating the first prompt based on the first queries and the related contents of the set theme, comprises:
obtaining a prompt template, wherein the prompt template comprises a first text to be replaced corresponding to the example referenced by the query to be generated and a second text to be replaced corresponding to the theme to which the query to be generated belongs; and
obtaining the first prompt by replacing the first text to be replaced based on the first query, and replacing the second text to be replaced based on the related contents of the set theme.

4. The method of claim 1, wherein generating the first text training sample for fine-tuning the second large model based on the second query, comprises:
generating a second prompt corresponding to the second query, wherein the second prompt is configured to indicate a rule based on which a response to the corresponding second query is generated;
generating a response corresponding to the second prompt through a third large model; and
generating the first text training sample based on the second prompt and the response.

5. The method of claim 4, wherein each of the second prompt corresponds to at least two responses,
generating the responses corresponding to the second prompt through the third large model, comprising:
inputting the second prompt into at least two different third large models to obtain responses output by the at least two different third large models respectively.

6. The method of claim 4, wherein each of the second prompt corresponds to at least two responses,
generating the response corresponding to the second prompt through the third large model, comprising:
generating the responses corresponding to the second prompt for multiple times through the third large model, wherein the responses generated each time are different,
wherein a response generated at the N^{th} time is an output obtained by inputting an updated prompt into the third large model, the updated prompt is obtained by splicing the second prompt with a response generated at the (N−1)^{th} time, and N is an integer greater than or equal to 2.

7. The method of claim 4, wherein generating the first text training sample based on the second prompt and the response, comprises:
taking the second prompt and the corresponding response as a candidate sample;
obtaining a quality of the candidate sample and corresponding sample optimization information, wherein the quality is determined based on at least one of a quality of the response and a correlation between the second prompt and the corresponding response; and
in response to the quality of the candidate sample not meeting a preset condition, obtaining an optimized candidate sample by optimizing the response based on the corresponding sample optimization information through the third large model that generates the response; and
generating the first text training sample based on the optimized candidate sample.

8. The method of claim 7, wherein obtaining the quality of the candidate sample and the corresponding sample optimization information, comprises:
generating a corresponding third prompt based on the candidate sample, wherein the third prompt is configured to indicate a rule based on which the quality of the candidate sample and the corresponding sample optimization information are generated; and
inputting the third prompt into a target evaluation model to obtain the quality of the candidate sample and the corresponding sample optimization information output by the target evaluation model.

9. The method of claim 8, further comprising:
obtaining a fourth prompt corresponding to a target sample, wherein the target sample comprises a sample prompt corresponding to a sample query and a corresponding sample response, the sample prompt is configured for indicating a rule based on which the sample response to the corresponding sample query is generated, and the fourth prompt is configured for indicating a rule based on which a quality of the target sample and corresponding sample optimization information are generated;
inputting the fourth prompt into a fourth large model to obtain the quality of the target sample and the corresponding sample optimization information output by the fourth large mode; and
modifying the quality of the target sample and the corresponding sample optimization information, determining the fourth prompt annotated by the modified quality of the target sample and the modified corresponding sample optimization information as a second text training sample, and obtaining the target evaluation mode by training an initial evaluation model based on the second text training sample.

10. The method of claim 7, wherein obtaining the optimized candidate sample by optimizing the corresponding response based on the corresponding sample optimization information through the third large model that generates the response, comprises:
obtaining an optimized prompt by splicing the second prompt with the sample optimization information;
obtaining an optimized response by inputting the optimized prompt into the third large model that generates the response; and
generating the optimized candidate sample based on the second prompt and the optimized response.

11. The method of claim 1, further comprising:
obtaining the at least two queries in at least one of the following ways:
in response to the second large model being online, collecting historical queries input into the second large model to obtain the at least two queries;
obtaining a network file, dividing the network file into at least two fragments, and obtaining the at least two queries based on the at least two fragments; or
obtaining the at least two queries input manually.

12. A method for fine-tuning a large model, comprising:
obtaining a first text training sample, wherein the first text training sample is generated based on the method of claim 1; and
fine-tuning a large model based on the first text training sample.

13. A question and answer method based on a large model, comprising:
obtaining a target query;
generating a prompt corresponding to the target query, wherein the prompt is configured to indicate a rule based on which a response corresponding to the target query is generated; and
obtaining a response corresponding to the prompt output by a large model by inputting the prompt into the large model, wherein the large model is a large model fine-tuned by using a first text training sample, and the first text training sample is generated based on the method of claim 1.

14. An electronic device, comprising:
a processor; and
a memory for storing instructions executable by the processor;
wherein when the instructions are executed by the processor, the processor is caused to perform:
obtaining at least two query clusters by clustering at least two queries;
obtaining a first query from each query cluster;
generating at least two second queries under a set theme through a first large model by taking the first query as an example; and
generating a first text training sample for fine-tuning a second large model based on the second query.

15. An electronic device, comprising:
a processor; and
a memory for storing instructions executable by the processor;
wherein when the instructions are executed by the processor, the processor is caused to perform:
obtaining a first text training sample, wherein the first text training sample is generated based on the method of claim 1; and
fine-tuning a large model based on the first text training sample.

16. An electronic device, comprising:
a processor; and
a memory for storing instructions executable by the processor;
wherein when the instructions are executed by the processor, the processor is caused to perform:
obtaining a target query;
generating a prompt corresponding to the target query, wherein the prompt is configured to indicate a rule based on which a response corresponding to the target query is generated; and
obtaining a response corresponding to the prompt output by a large model by inputting the prompt into the large model, wherein the large model is a large model fine-tuned by using a first text training sample, and the first text training sample is generated based on the method of claim 1.

17. A non-transitory computer-readable storage medium having computer instructions stored thereon, wherein the computer instructions are configured for causing a computer to execute a method for generating a text training sample based on a large model, the method comprising:
obtaining at least two query clusters by clustering at least two queries;
obtaining a first query from each query cluster;
generating at least two second queries under a set theme through a first large model by taking the first query as an example; and
generating a first text training sample for fine-tuning a second large model based on the second query.

18. The storage medium of claim 17, the generating the at least two second queries under the set theme through the first large model by taking the first query as the example, comprises:
generating a first prompt based on the first query and related contents of the set theme, wherein the first prompt is configured for indicating an example referenced by a query to be generated and a theme to which the query to be generated belongs; and
obtaining the second query by inputting the first prompt into the first large model.

19. A non-transitory computer-readable storage medium having computer instructions stored thereon, wherein the computer instructions are configured for causing a computer to execute a method for fine-tuning a large model, the method comprising:
obtaining a first text training sample, wherein the first text training sample is generated based on the method of claim 1; and
fine-tuning a large model based on the first text training sample.

20. A non-transitory computer-readable storage medium having computer instructions stored thereon, wherein the computer instructions are configured for causing a computer to execute a question and answer method based on a large model, the method comprising:
obtaining a target query;
generating a prompt corresponding to the target query, wherein the prompt is configured to indicate a rule based on which a response corresponding to the target query is generated; and
obtaining a response corresponding to the prompt output by a large model by inputting the prompt into the large model, wherein the large model is a large model fine-tuned by using a first text training sample, and the first text training sample is generated based on the method of claim 1.
